(19) United States
(12) Patent Application Publication
(10) Pub. No.: US 2009/0193978 A1
(43) Pub. Date: Aug. 6, 2009

(54) Conical fermentor

(76) Inventor: John Richard Blichmann, Lafayette, IN (US)

Correspondence Address: John R Blichmann, 912 Logan Ave, Lafayette, IN, 47905, US

(21) Appl. No.: 12/317,555

(22) Filed: Dec. 23, 2008

Related U.S. Application Data
(63) Continuation-in-part of application No. 10/873,791, filed on Jun. 22, 2004, now abandoned.

(51) Int. Cl. C12C 1/00

(52) U.S. Cl. 99/276

(57) ABSTRACT

An improved homebrewing conical fermentor having pressure capability for CO2 pumping and carbonation, without welding onto the tank, which can lead to contamination of the fermenting product. In addition, the fermentor support legs remain permanently affixed to the tank without introducing any welding flaws on the inside of the tank. A removable access hatch is provided, again without any welding onto the tank lid. A lid seal is provided with a bead that improves sealing capability against the tank lip. Lastly, a removable lid design utilizing a band clam that eliminates the need to weld the lid to the tank and allows for easy access to the interior of the fermentor for cleaning and sanitation.

This application is a continuation in part of application Ser. No. 10/873,791, filed Jun. 22, 2004 now abandoned.

### BACKGROUND

1. Field of the Invention

This invention relates generally to fermentors, specifically to conical fermentors for homemade beer and wine making

2. Discussion of Prior Art

It is well known in the art to utilize a conical bottomed fermentor for fermenting beer or wine. The spent yeast and other fermentation materials settle to the bottom of the cone and can be easily removed by a drain valve located at the bottom of the cone. This eliminates the need to transfer (rack) the beer or wine to another container for secondary fermentation, and avoids the risk of contamination and oxidation.

Such conical fermentors for commercial breweries also have pressure capability for sanitarily pumping the finished product via CO2 pressure, and for forced carbonation of the finished product. Prior art homebrew fermentors utilize flat lids secured to the top of the fermentor with a clamping foot in the center of the lid. Others use a series of clamps or latches around the perimeter of the lid. Both of these prior art designs do not tolerate pressure due to the flexing of the lid due to uneven or inadequate clamping force and leak gas if pressurized, thereby preventing CO2 pumping or pressure carbonation.

Due to the large size of commercial fermentors, they are necessarily made from formed sheets of material (usually stainless steel or copper) welded together and carefully ground and polished on the interior to remove pits and other weld flaws which hide bacterial and contaminate the fermenting product. Legs are then welded to the exterior of the fermentor so that it may be set on a floor. Also provided is an access hatch for the adding of hops, finings, and the like, to the fermentor during the fermentation process and also to facilitate cleaning.

Prior art homebrewing conical fermentors are derivatives of the large commercial fermentors, but are constructed from commercially available “hoppers”. These hoppers are formed from flat stainless sheet, deep-drawn into a pot, and them have a cone spun on the bottom without any welding whatsoever. This eliminates any risk of pitting and flaws associated with welding and the bacterial contamination that can ensue. In addition, the manufacturing costs are substantially lower using this method of manufacture.

However, affixing mounting legs, even through welded from the outside, leaves unavoidable permanent marking and burn-through pitting due to the comparatively thin walls of these commercially available one-piece drawn and spun tanks. Clamp-on leg designs exist, but are expensive to manufacture and clumsy to install and use. Other designs use a stand that does not remain affixed to the fermentor when moved, or for cleaning which is yet another large disadvantage for a small homebrew sized fermentor which are typically carried and cleaned in a household sink.

Lid seals for prior art fermentors are typically “U” shaped elastomeric seals that are placed over the edge of the tank lip or lid. Since the surfaces of these tank lips and lids are not perfectly flat, getting a gas and liquid tight seal is difficult and unreliable. Any air infiltration into the fermentor will stale (oxidize) the fermenting product negatively affecting the flavor.

Providing an access hath in homebrew-sized fermentor is typically done by welding the top of a stainless soda keg onto the top of the fermentor as taught by the Sabco Company. However, this welding process can leave weld flaws and the associated problems of contamination, In addition, this is a costly method to provide this feature.

Finally, providing pressure capability without welding the lid onto the tank is unavoidable in prior art fermentors due to structural pressure limitations, making cleaning the small homebrewing fermentor very cumbersome since internal surfaces are difficult or impossible to reach.

### OBJECTS AND ADVANTAGES

Accordingly, it is an object of this invention to provide a conical fermentor with pressure capability without welding the lid onto the fermentor.

It is yet another object of the invention to provide an access hatch without welding onto the fermentor.

It is yet another object of this invention to provide a fermentor leg design that remains affixed to the fermentor for ease of cleaning and portability, but does not leave weld flaws on the interior of the fermentor.

It is a final object of the invention to provide a completely gas and liquid tight fermentor lid seal.

Further objects and advantages of my invention will become apparent from a consideration of the drawings and ensuring description.

### DESCRIPTION OF DRAWINGS

FIG. 1a and FIG. 1b show a side cut-away and top view of a preferred embodiment of fermentor leg assembly, the fermentor being generally circular in configuration. FIG. 2a shows an alternative embodiment where a nut is used in lieu of a spacing collar. FIG. 2b shows an alternate embodiment where a collared stud is utilized in lieu of a spacing collar. FIG. 2c shows an alternate embodiment where an internally threaded standoff is utilized in lieu of a spacing collar. FIG. 2d shows and alternate embodiment where legs contain mounting flanges and leg is directly bolted to tank without spacers, collars of backing nuts.

FIG. 3a shows the preferred embodiment of beaded lid seal design. FIG. 3b shows and alternate embodiment of lid seal where bead is replaced with an edge-type design. FIG. 3c shows an alternate embodiment of lid seal where bead is replaced with a wiper-type design.

FIG. 4a shows the preferred embodiment of lid sealing mechanism. FIG. 4b shows an alternate embodiment where a clamp ring is used to reduce seal buckling when tightening. FIG. 4c shows and alternate embodiment where tank lip is a beaded design. FIG. 4d shows and alternate embodiment where a support ring is utilized to hold the seal properly in place and reduce seal bunching when tightening.

FIG. 5a shows a standard soda keg hatch assembly installed in a standard soda keg top. FIG. 5b shows standard soda keg hatch assembly with shortened legs installed on a flat lid thereby reducing manufacturing and tooling costs. FIG. 5c shows an alternate embodiment whereby stamped soda keg hatch lip profile is stamped directly onto the lid, thereby eliminating the need to shorten the hatch legs.

### DESCRIPTION OF THE PREFERRED EMBODIMENTS

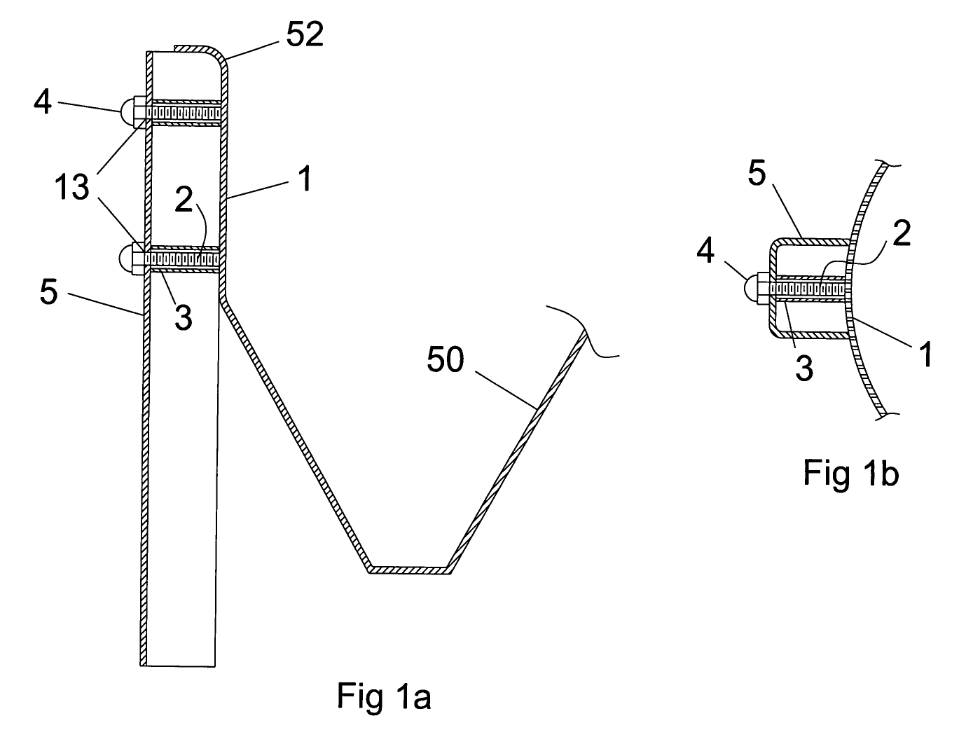

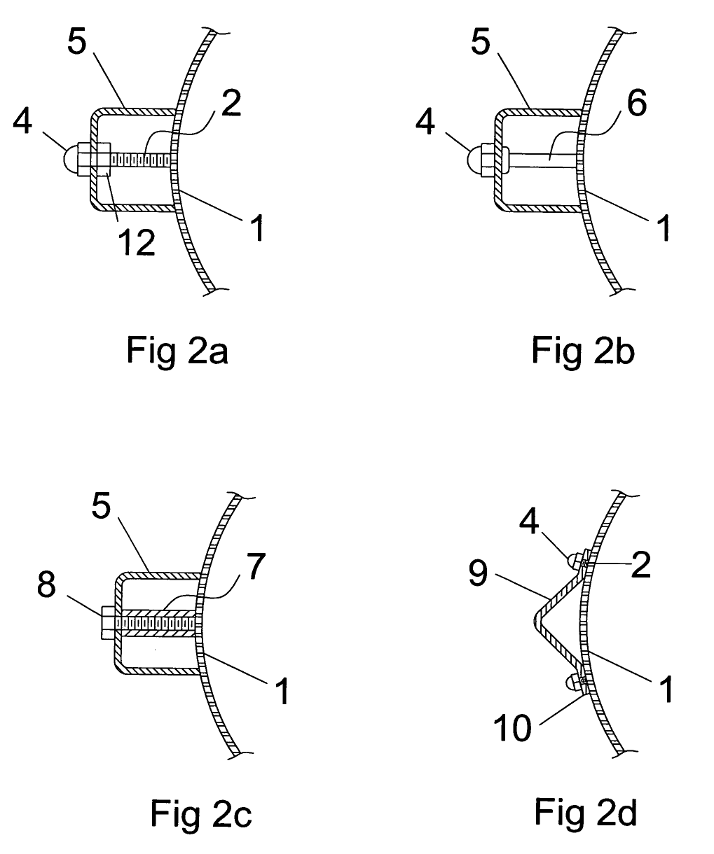

Referring to the drawings, and particularly FIGS. 1a and FIG. 1b, a generally circular tank 1 is fitted with at least one capacitive discharge (CD) or arc studs 2. In the preferred embodiment, shown in FIG. 1a and FIG. 1b, a spacer 11 is placed over stud 2 to allow for full bolt torque. Leg 5, having appropriately placed mounting holes 13, is placed over studs 2 and fastened to tank 1 with nuts 4. At least three legs 5, are installed on tank 1, preferably 120 degrees apart for optimum stability.

In an alternate embodiment shown in FIG. 2a, a backing nut 12 is placed on stud 2 to the appropriate height. Leg 5 is then installed over studs 2 and secured with nut 4.

An alternate embodiment shown in FIG. 2b utilizes a collared stud 6, eliminating the need for spacer 3.

Another embodiment shown in FIG. 2c utilizes an internally threaded stand-off 7 in lieu of stud 2 and utilizes a cap screw 8 to affix leg 5 to tank 1. Internally threaded stand-off 7 eliminates the need for spacer 3 or collar on stud 6. Yet another embodiment shown in FIG. 2d utilizes a leg 9 with flanges 10 whereby studs 2 affix the leg to tank 1. Further embodiments not shown in the drawings include tubes, bars, “H” sections etc.

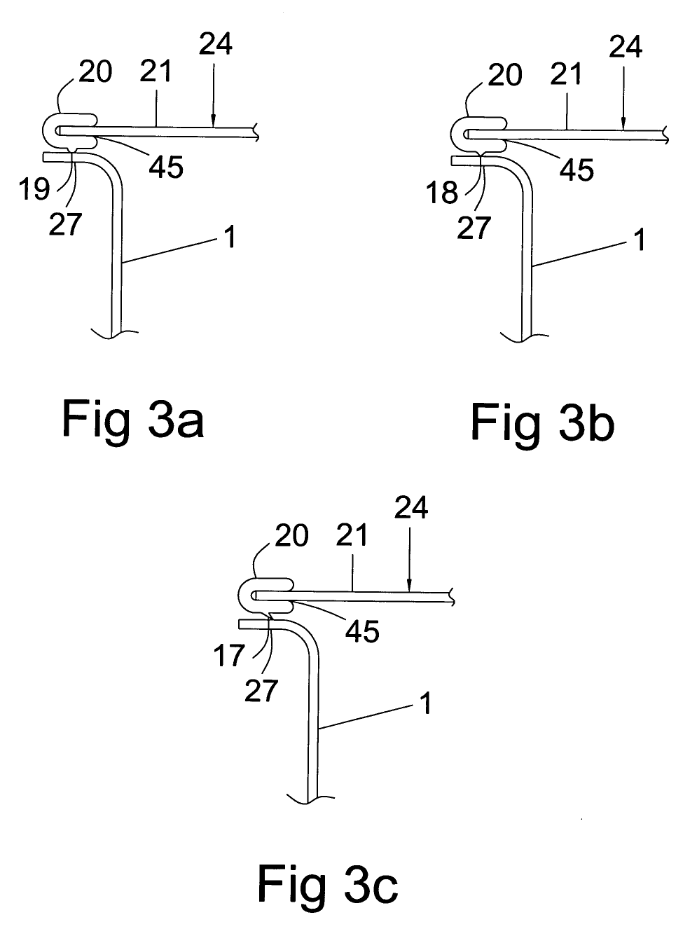

FIG. 3a shows a seal 20 with a bead 19 and a cavity 45 to receive lip of tank lid 21 or tank lip 27. The tank 1 is formed from a plate in a spin forming operation. The plate has a preestablished thickness enabling the spinning operation to be operable. The tank 1 is conical and defines a bottom portion 50 and has an opening 52 therein being positioned opposite the bottom portion 50. The tank lip 27 extends from the opening 52. The tank lip 27 has a cylindrical configuration and defines an outer diameter 54 and an inner diameter 56. A radius is interposed the tank lip 27 and the bottom portion 50. The outer diameter is spaced from the inner diameter a preestablished distance. The preestablished distance is determined by the sum of the radius and a flat portion 58. In this application, the radius is about 15 mm and the preestablished distance is about 30 mm. Thus, the flat portion 58 also has a distance being equivalent to about 15 mm. The flat portion 58 defines a first surface 60 and a first sealing surface 62 along the flat portion 58 being position parallel and opposite one another by the thickness of the plate. The tank lid 21 has an outer diameter 70 being larger than the inner diameter 56 of the tank lip 21. In this application, the outer diameter of the tank lid 21 is smaller than the outer diameter 54 of the tank lip. The tank lid 21 is formed from a plate having a first side 72 and a second side 74. At least one of the first side 72 and the second side 74 has a sealing surface 76 thereon. The sealing surface 76 extends from the outer diameter 70 toward the inner diameter 56 of the tank lip 21 a preestablished distance. In this application, the preestablished distance of the sealing surface 76 is about 20 mm. Ideally, the flat portion 58 of the tank lip 27 and the sealing surface 76 of the tank lid 21 are flat. However, it is contemplated that the flatness of flat portion 58 and the sealing surface 76 can have between a 5 and 10 degrees variation due to manufacturing tolerances. Thus, the need for the seal 20. The cavity 45 is formed by a base 46 having a pair of legs 48 extending from the base 46 a preestablished distance. In this application, the preestablished distance of the pair of legs 48 is less than the preestablished distance of the flat portion 58 of the tank lip 27. The seal 20 is preferably constructed of a flexible elastomeric material. Seal 20 has a first sealing surface 80 and a second sealing surface 82 being utilized to provide a gas and liquid tight seal against tank lip 27 and lid 21. Bead 19 and seal 20 experiences a high localized pressure from a lid clamping force 24 and as a result deforms and creates a positive seal against tank lip 27 alternately, bead 19 can be shaped into numerous profiles such as edge 18 as shown in FIG. 3b and wiper 17 as shown in FIG. 3c.

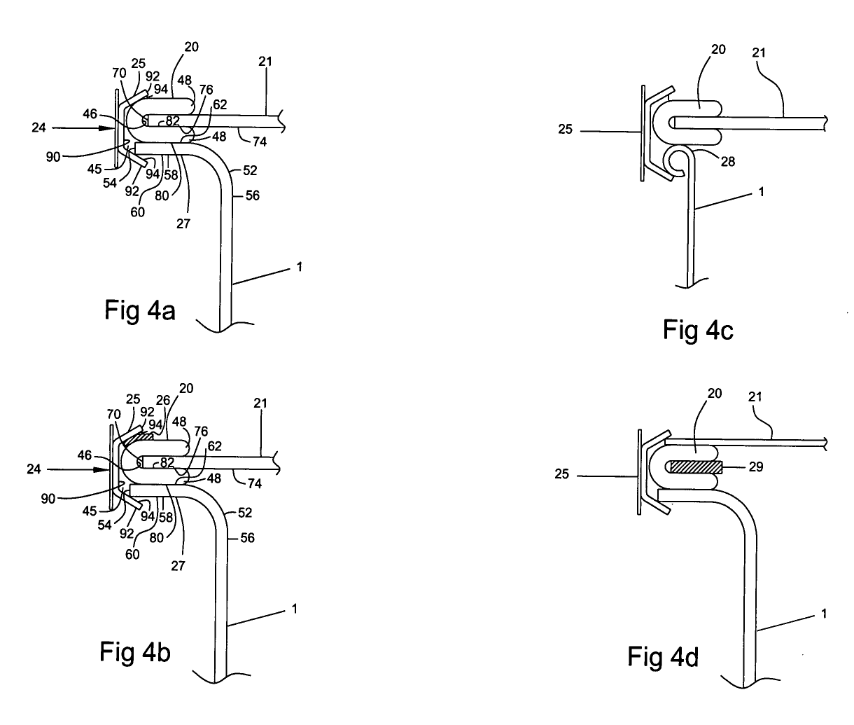

FIGS. 4a-d shows alternate methods to seal lid 21 against tank lip 27 using a band clamp 25 and seal 20 (shown without bead 19). The band clamp 25 has a preestablished open size and a preestablished closed size and can be tightened therebetween. The band clamp 25 has a cross-section defining a base portion 90 having a pair of legs 92 extending therefrom at an angle. In this application, the angle of each of the pair of legs 92 to the base portion 90 is about 30 degrees. However, it is contemplated that the angle could be between 15 and 45 degrees and functionally performs the clamping operation. Each of the pair of legs 92 defining a wedging surface 94 being in wedging relationship with one of the tank lip 21 and tank lid 27, and the seal 20. For example in operation as shown in FIG. 4a, the wedging surface 94 of one of the pair of legs 92 is in contacting relationship with the seal 20 and the first surface 60 of the tank lip 27. And, in operation as shown in FIG. 4d, the wedging surface 94 of one of the pair of legs 92 is in contacting relationship with the first surface 60 of the tank lip 27 and the wedging surface 94 of the other of the pair of leg 92 is in contacting relationship with the first side 72 of the tank lid 21.

In the preferred embodiment, shown in FIG. 4a, band clamp 25 provides clamping force 24 when tightened. FIG. 4b shows a clamp ring 26 preferably made from steel or hard plastic, which allows band clamp 25 to tighten with reduced bunching of seal 20. FIG. 4c shows a beaded lid lip 28 on tank 1. FIG. 4d shows yet another embodiment utilizing a seal support ring 29 that supports seal 20 during tightening of band clamp 25. Obviously, many combinations of similar band clamp assembly designs could be conceived, such as placing seal 20 on the lip of tank 1 instead of lid 21.

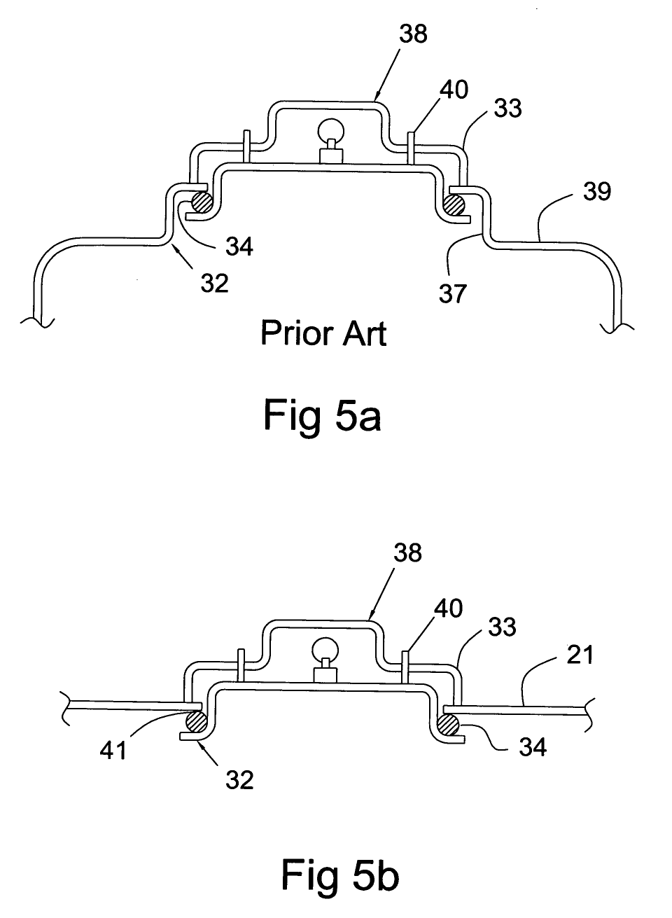

FIG. 5a shows a standard soda keg hatch assembly 32 installed in a standard soda keg top 39. A pair of hatch legs 33 on a handle assemble 38 is rotatably affixed about a hinge point 40. A hatch seal 34 is placed between lid assembly 32 and soda keg top 39.

FIG. 5b shows the preferred embodiment of the invention where hatch legs 33 are shortened to allow lid 21 with a flat sealing surface 41 to be utilized in lieu of a stamped soda keg hatch lip 37 in soda keg top 30 having a form-fitting profile as shown in FIG. 5a. Alternately, lid 21 can be manufactured with a standard soda keg hatch lip 37 as an integral part of the lid as shown in FIG. 5c, thereby eliminating the need to shorten hatch legs 33.

### OPERATIONS OF THE PREFERRED EMBODIMENT

Referring to FIGS. 1a and 1b, stud 2 is welded to tank wall 1 utilizing a typical capacitive discharge or arc stud welding process. This welding process is ideally suited to welding studs and stand-offs to thin sheet steel leaving absolutely no marking or the opposite side of the sheet. Due to the extremely short arch duration of a CD or acc stud welding machine, the energy is concentrated in a very small area resulting in a strong weld and small heat affected zone. Since the interior side (opposite the stud) of the sheet is not heated substantially, there is absolutely no risk of burn through or pitting and through associated contamination issues. Yet the weld is permanent and very strong. In the preferred embodiment, spacer 3 is placed over stud 2. Leg 5 is then installed over stud 2 and nut 4 compresses leg 2 into spacer 3, spacer 3 enabling full bolt torque. Although spacer 3 could be eliminated, full bolt torque cannot be applied resulting in an unsatisfactory, unsafe bolted joint design.

In an alternate embodiment, stud backing nut 12 is placed on stud 2 to the height dictated by leg 5 so legs rest against tank wall 1. Leg 5 is placed over stud 2 and fastened with nut 4, securing leg 5 to tank 1 with proper full bolt torque.

Alternately, stud 2 can be collared stud 6 as shown in FIG. 2a where collar on stud 6 allows for full bolt torque. In yet another embodiment, a threaded standoff 7 is welded to tank 1 and cap screw 8 affixes leg 5 to the tank allowing for proper bolt torque. In another embodiment, shown in FIG. 2d, leg 9 is manufactured with flange 10. Flange 10 is held to tank 1 with stud 2 and nut 4. Obviously, many possible ramifications could be conceived utilizing tubes, 14 channels, bars, and the like in conjunction with the various variety of CD or arc weld fittings commercially available or custom manufactured to affix a leg to the fermentor.

A lid 21 is sealed against tank lip 27 with seal 20 containing bead 19 as shown in FIG. 3a. Cavity 45 of seal 20 is placed over lid 21. Alternately, cavity 45 can be placed over tank lip 27. As lid clamping force 24 is applied to lid 21 bead 19 experiences a high localized pressure and forms tightly against tank lip 27 creating a gas and liquid tight seal. Lid clamping force 24 can be from a multiple sources including, but not limited to, a pressure foot, drawn latch, toggle clamp, or similar prior art means. Bead 19 can be many alternate shapes such as edge 18 shown in FIG. 3b, and wiper 17 shown in FIG. 3c.

As shown in FIG. 4a, clamp force 24 can be provided by a band clamp 25 placed over seal 20 and tank lip 27 encapsulating lip 21. Since typical band clamps provide high sealing forces, bead 19 is not required to function properly. FIG. 4b shows clamping ring 26, which prevents seal 20 from bunching during tightening. FIG. 4c shows an alternate beaded tank lip 28. FIG. 4d shows a seal support ring 29 used to support seal 20 when band clamp 25 is tightened. Obviously, band clamp 24 can be numerous shapes such as “V” shaped, “U” shaped, or many other common configurations.

FIG. 5a shows a standard soda keg hatch assembly 32 installed in a standard soda keg top 39. Since these lids are mass produced they are very cost effective and ideally suited for a homebrew sized fermentor access hatch. A pair of hatch legs 33 on handle assembly 38 is rotatably affixed about a hinge point 40. A hatch seal 34 is placed between lid assembly 32 and soda keg top 39. When handle assembly 38 is rotated about hinge pint 40, hatch legs 33 drive standard soda keg hatch assembly 32 upward thereby compressing hatch seal 34 creating a gas and liquid tight seal. FIG. 5b shows the preferred embodiment of the invention where legs 33 are shortened to compensate for the elimination of stamped soda keg hatch lip 37 in soda keg top 39 as shown in FIG. 5a. This allows for a simpler flat lid sealing surface 41 eliminating expensive stamping tooling or secondary manufacturing operations. Alternately, lid 21 can be manufactured with a standard soda keg hatch lip 37 profile stamped into it as an integral part of the lid as shown in FIG. 5c, thereby eliminating the need to shorten hatch legs 33. Depending on intended design pressure, it may be necessary to form the remaining surfaces of the lid into a dome shape to reduce lip flexing.

### SUMMARY, RAMIFICATIONS, AND SCOPE

Thus the reader will see that the improved conical fermentor provides the homebrewer with all the features of a commercial conical fermentor but does so without any chance of introducing welding flaws in the interior of the fermentor. While my description contains many specificities, these should not be construed a limitations of the scope of the invention, but rather as and exemplification of one preferred embodiment thereof. Many other variations of lid seal profiles, band clamp profiles, leg shapes, and leg clamping configurations are obviously possible. Accordingly, the scope of the invention should be determined not by the embodiments illustrated, but by the appended claims and their legal equivalents.

1. A sealing clamp assembly for use with a fermentor, said fermentor being used for making homemade beer and wine comprising:
a tank being conical and having a bottom portion and an opening therein being positioned opposite the bottom portion;
a lip extending from said opening, said lip being cylindrical and defining an outer diameter and an inner diameter, said outer diameter being spaced from said inner diameter a preestablished distance, and said lip being flowingly connected to said bottom portion, said lip defining a first surface and a sealing surface, said first surface and said sealing surface being positioned opposite one another and generally parallel to one another;
a lid defining an outer diameter being larger than said inner diameter of said lip and said lid having a first side and a second side, said first side and said second side being positioned opposite one another and generally being parallel one to another, at least one of said first side and said second side having a sealing surface, said sealing surface extending from said outer diameter toward said inner diameter;
a seal having a first sealing surface being in contacting relationship with said sealing surface of said lip and a second sealing face being in contacting relationship with said sealing surface of said lid;
a clamp having a cross-section defining a base portion and having a pair of legs extending therefrom, said pair of legs extended from said base portion at an angle having a generally “V” configuration, said clamp forming a band type configuration being tightenable, each of said pair of legs defining a wedging surface, one of said wedging surface of each of said pair of legs being in contacting relationship with one of said first surface of said lip and said first side of said lid.

2. The sealing clamp assembly of claim 1 wherein said other of said wedging surface of said pair of legs being in contacting relationship with said seal.

3. The sealing clamp assembly of claim 1 wherein said other of said wedging surface of said pair of legs being in contacting relationship with a clamp ring.

4. The sealing clamp assembly of claim 1 wherein said seal having a generally “U” shaped configuration defining a cavity and having a pair of legs extending along said cavity, one of said pair of legs having the first sealing surface and a second sealing surface.

5. The sealing clamp assembly of claim 4 wherein the other of said pair of legs being in contacting relationship with said lid and said wedging surface of said clamp.

6. The sealing clamp assembly of claim 1 wherein said seal having a generally “U” shaped configuration defining a cavity having a base and a pair of legs extending from said base and a support ring being positioned within said cavity and said seal being in contacting relationship with said lip and said lid.

7. The sealing clamp assembly of claim 1 wherein said seal includes a bead.

8. The sealing clamp assembly of claim 1 wherein said seal includes a wiper.

9. The sealing clamp assembly of claim 1 wherein said clamp having a predetermined open size and a predetermined close size.

10. The sealing clamp assembly of claim 1 wherein said angle of said pair of legs being between 15 and 45 degrees.

11. The sealing clamp assembly of claim 1 wherein said lid has a standard soda keg hatch lip attached thereto.

12. A sealing clamp assembly for use with a fermentor, said fermentor being used for making homemade beer and wine comprising:
a tank being conical and having a bottom portion and an opening therein being positioned opposite the bottom portion;
a lip extending from said opening, said lip being cylindrical and defining an outer diameter and an inner diameter, said outer diameter being spaced from said inner diameter a preestablished distance, and said lip being flowingly connected to said bottom portion, said lip defining a first surface and a sealing surface, said first surface and said sealing surface being positioned opposite one another and generally parallel to one another;
a lid defining an outer diameter being larger than said inner diameter of said lip and said lid having a first side and a second side, said first side and said second side being positioned opposite one another and generally being parallel one to another, at least one of said first side and said second side having a sealing surface, said sealing surface extending from said outer diameter toward said inner diameter;
a seal having a generally “U” configuration defining a cavity therein, a first sealing surface being in contacting relationship with said sealing surface of said lip;
a clamp ring being at least partially interposed within said cavity;
a clamp having a cross-section defining a base portion and having a pair of legs extending therefrom, said pair of legs extended from said base portion at an angle having a generally “V” configuration, said clamp forming a band type configuration being tightenable, each of said pair of legs defining a wedging surface, one of said wedging surface of each of said pair of legs being in contacting relationship with one of said first surface of said lip and said first side of said lid.

14. The sealing clamp assembly of claim 1 wherein said seal includes a bead.

15. The sealing clamp assembly of claim 1 wherein said seal includes a wiper.

16. The sealing clamp assembly of claim 1 wherein said clamp having a predetermined open size and a predetermined close size.

17. A sealing clamp assembly for use with a fermentor, said fermentor being used for making homemade beer and wine comprising:
a tank being conical and having a bottom portion and an opening therein being positioned opposite the bottom portion;
a lip extending from said opening, said lip being cylindrical and defining an outer diameter and an inner diameter, said outer diameter being spaced from said inner diameter a preestablished distance, and said lip being flowingly connected to said bottom portion, said lip defining a first surface and a sealing surface, said first surface and said sealing surface being positioned opposite one another and generally parallel to one another;
a lid defining an outer diameter being larger than said inner diameter of said lip and said lid having a first side and a second side, said first side and said second side being positioned opposite one another and generally being parallel one to another, at least one of said first side and said second side having a sealing surface, said sealing surface extending from said outer diameter toward said inner diameter;
a seal having a first sealing surface being in contacting relationship with said sealing surface of said lip and a second sealing surface being in contacting relationship with said sealing surface of said lid;
a clamp having a cross-section defining a base portion and having a pair of legs extending therefrom, said pair of legs extended from said base portion at an angle having a generally “V” configuration, said clamp forming a band type configuration being tightenable, each of said pair of legs defining a wedging surface, one of said wedging surface of said pair of legs being in contacting relationship with one of said first surface of said lip;
a clamp ring being interposed said seal and said wedging surface of one of said pair of legs.

18. The sealing clamp assembly of claim 1 wherein said seal includes a bead.

19. The sealing clamp assembly of claim 1 wherein said seal includes a wiper.

20. The sealing clamp assembly of claim 1 wherein said clamp having a predetermined open size and a predetermined close size.
